(19) United States
(12) Patent Application Publication
(10) Pub. No.: US 2024/0034310 A1
(43) Pub. Date: Feb. 1, 2024

(54) METHOD AND CONTROL DEVICE FOR DETERMINING A COLLISION-RELEVANT TIME VARIABLE FOR A MOTOR VEHICLE

(71) Applicant: VOLKSWAGEN AKTIENGESELLSCHAFT, Wolfsburg (DE)

(72) Inventors: Marcel AGUIRRE MEHLHORN, Wolfsburg (DE); Hendrik DECKE, Braunschweig (DE)

(21) Appl. No.: 18/247,910

(22) PCT Filed: Oct. 1, 2021
(86) PCT No.: PCT/EP2021/077146

§ 371 Date: Oct. 16, 2023

(30) Foreign Application Priority Data
Oct. 8, 2020 (DE) 10 2020 212 689.5

(51) Int. Cl. B60W 30/09; B60W 30/095

(52) U.S. Cl. CPC B60W 30/09; B60W 30/0956; B60W 2554/80

(57) ABSTRACT

A control device and a method for determining a time variable which is a time variable for describing a possible collision of an ego-vehicle with at least one further object. The method includes determining a movement variable which is based on a movement of at least one of the ego-vehicle and the object; determining a current and/or possible location area for at least one of the ego-vehicle and the object; determining the time variable based on the movement variable and the location area, the location area is determined based on a surroundings model of the ego-vehicle.

### PRIORITY CLAIM

This patent application is a U.S. National Phase of International Patent Application No. PCT/EP2021/077146, filed 1 Oct. 2021, which claims priority to German Patent Application No. 10 2020 212 689.5, filed 8 Oct. 2020, the disclosures of which are incorporated herein by reference in their entireties.

### SUMMARY

Illustrative embodiments relate to a control device and to a method for ascertaining a temporal parameter, wherein the temporal parameter describes a possible collision of an ego vehicle with at least one further object.

### BRIEF DESCRIPTION OF THE DRAWINGS

Exemplary embodiments will be explained below with reference to the figures that follow. For all figures, the same reference signs can be used for features of the same type or having the same effect.

FIG. 1 shows a schematic method principle for ascertaining a time-to-collision;

FIG. 2 shows a schematic method principle for ascertaining a time-to-brake;

FIG. 3 shows a schematic method principle for ascertaining a time-to-steer;

FIG. 4 shows a schematic method principle for ascertaining a time-to-kickdown; and

FIG. 5 shows a schematic method principle for ascertaining a time-to-enter and time-to-disappear.

### DETAILED DESCRIPTION

The term ego vehicle is understood to mean a vehicle (in particular, a transportation vehicle and furthermore, in particular, a passenger car or a truck) to which the measures described herein are applied or for which the collision-relevant temporal parameter is determined. This ego vehicle should be considered to be different from further transportation vehicles which are located in the vicinity of the ego vehicle and with which collisions and, in particular, rear-end collisions are to be avoided. These transportation vehicles are examples of objects described herein. The ego vehicle can comprise, for example, the control device described herein.

It is known to monitor the vehicle vicinity of an ego vehicle using sensors and also to generate based thereon vicinity models, for example. If collision-relevant objects (in particular, other transportation vehicles, but also static objects such as, for example, traffic infrastructure) are detected in the vehicle vicinity, various temporal parameters can be determined that describe possible collision scenarios. In particular, these are temporal parameters that must be observed to avoid an actual collision. These parameters are also referred to as TTX (time-to-X), with “X” being a placeholder for a collision scenario that is currently being considered. These temporal parameters can also be referred to as behavioral safety metrics (or metrics, for short). Reference is made to the following prior art, which discloses further background in this respect:

Spieker A. M. and Kroschel K, Hillenbrand J. A: “multilevel collision mitigation approach—Its situation assessment, decision making, and performance tradeoffs,” IEEE, Transactions on intelligent transportation systems, 2006;

Kristian Kroschel, Jörg Hillenbrand and Volker Schmid, “Situation Assessment Algorithm for a Collision Prevention Assistant,” 2005;

M. M. Minderhoud and P. H. L. Bovy, “Extended time-to collision measures for road traffic safety assessment,” Accident Analysis and Prevention, 2001.

Until now, the behavior safety metrics have been calculated deterministically, for which the abovementioned prior art specifies various calculation approaches. These have in common that typically complex case discriminations must be made, which is not always successful with sufficient reliability during real driving operation. Overall, this causes high demands in terms of computational resources and the programming complexity required. For example, the computational methods are analytical and/or numerical and can also require integral calculations or iterative solution approaches, which correspondingly increases the complexity of the calculation.

In addition, these methods are frequently directly based on sensor measurement values, for example, of a distance measurement. If the sensors record incorrect data and/or if transmission delays occur, the risk of collision may be ascertained incorrectly.

It follows that there is a demand for assessing possible collisions of an ego vehicle with objects in the environment reliably yet without great complexity, in particular, by collision-describing temporal parameters that are determined for this purpose.

This is achieved by a method and by a control device.

Generally, it is proposed to use two-dimensional (and/or geometric) considerations as a basis and/or to assess possible collisions on the basis of corresponding two-dimensional considerations. In particular, regions occupied by the ego vehicle (for example, a current occupied region or a future occupied region that can be modeled, for example, as a two-dimensional travel corridor or braking corridor) are considered. These may be defined in a vicinity model (or environment model) of the transportation vehicle and are thus not necessarily dependent directly, but merely indirectly on direct sensor recordings of the environment.

Instead of being forced to work directly with sensor measurement values and, in particular, without being limited thereto, the parameters required for collision considerations in the present case are at least in part derived from a vicinity model containing potentially more suitable information. It is to be understood here that, owing to the variety of data sources on which the vicinity model is based, the vicinity model can contain contents and/or information that go/goes beyond pure (individual) sensor measurement values.

It has been shown that the calculation of temporal parameters describing the possible collision is then considerably simplified. In particular, the behavior safety metrics of the prior art (i.e., in particular, the corresponding TTX temporal parameters), which have until now been calculated with complexity and have in part been determinable only iteratively, are determinable with little complexity and yet reliably. It is also possible to use all the information from the vicinity model for this purpose, but there is no need to directly work with directly recorded sensor data.

Where two-dimensional occupied regions are mentioned herein, these can be defined by a plurality of locations that lie in the occupied region and/or delimit the occupied region. That is to say, it is not absolutely necessary to calculate or define complete areas. Rather, a plurality of individual points and, in particular, two-dimensional coordinates thereof which are distributed two-dimensionally and delimit or span, for example, the occupied regions can be used. One exemplary embodiment makes provision for the occupied region to be described by at least two points or locations for which in each case at least two-dimensional coordinates are determined. However, the present solution is in principle also applicable to three-dimensional considerations, for example, by determining correspondingly three-dimensional occupied regions.

In particular, a method for ascertaining a temporal parameter (in particular, a TTX temporal parameter and/or a behavior safety metric) is proposed, wherein the temporal parameter describes a possible collision of an ego vehicle with at least one further object. The method here may include:
ascertaining a movement parameter that is dependent on a movement of at least one of the ego vehicle and the object;
ascertaining a (optionally, at least two-dimensional) current and/or (for example, future) possible occupied region for at least one of the ego vehicle and the object;
ascertaining the temporal parameter on the basis of the movement parameter and the occupied region.

The occupied region may be ascertained here on the basis of a vicinity model of the ego vehicle or, in other words, is derived from the vicinity model and/or is defined in the vicinity model. Generally speaking, all further considerations, calculations and determinations discussed herein can also take place with consideration and/or on the basis of the vicinity model. This is true for the determination of measurement parameters, in particular, for other transportation vehicles than the ego vehicle, and/or the extent of expected occupied regions, in particular, braking or travel corridors. All distances or other parameters required for assessing a risk of collision can also be derived from the vicinity model and do not necessarily correspond to direct (individual) sensor measurement values.

The movement parameter can be a relative speed between the ego vehicle and the object. It can be determined using sensors of the ego vehicle. For example, the latter can determine for this purpose the speed of objects in the environment and, in particular, of further transportation vehicles located in the environment by vicinity sensors, in particular, distance sensors.

To ascertain the occupied region, the ego vehicle can determine its own spatial coordinates, for example, in the (optionally, at least two-dimensional) vicinity model. For example, if the dimensions of the ego vehicle are known, its outlines can be at least roughly approximated, for example, its outline in a horizontal plane. Generally, any two-dimensional parameters and/or regions discussed herein can be determined in a correspondingly horizontal plane which extends, for example, parallel to a (planar) vehicle driving surface.

The possible occupied region can be a future possible occupied region that is determined, for example, on the basis of an expected trajectory, an expected braking behavior, or an expected driving behavior of the ego vehicle. As a future possible occupied region for the object, for example, a movement parameter of the object can be recorded by vicinity sensors of the ego vehicle. For example, an expected travel corridor of the object can then be two-dimensionally calculated and/or modeled as a possible occupied region, for example, if the driving direction and/or speed of the object have been recorded.

As an alternative or in addition to the ego vehicle detecting the object using sensors, the object can also transmit relevant parameters by a communication link to the ego vehicle. For example, it can communicate its own dimensions (in particular, for defining the region it currently occupies) or at least a movement parameter (for example, for defining a future possible occupied region) to the ego vehicle. What is known as V2X (vehicle-to-X) communication of the ego vehicle, for example, with intelligent traffic infrastructure, is also possible for obtaining such parameters.

According to a disclosed embodiment, the temporal parameter is ascertained on the basis of a distance and a minimum distance between the occupied region and the correspondingly other one of the ego vehicle and the object. For example, it is possible based on the distance to determine the temporal parameter up to the point when the correspondingly other one of the ego vehicle and the object enters the occupied region. Generally, provision may also be made for two-dimensional occupied regions to be determined both for the ego vehicle and also for the object. In that case, it is also possible to ascertain when the occupied regions overlap or how much time remains until a corresponding overlap, which may be a collision, occurs. This can also again take place on the basis of the vicinity model or of information modeled thereby.

In particular, provision may be made for the temporal parameter to be determined on the basis of a quotient of the optional minimum distance and the movement parameter (more specifically the minimum distance divided by the movement parameter). The movement parameter is here optionally the abovementioned relative speed between the ego vehicle and the object.

Generally, any of the embodiments mentioned below, which are known per se from the prior art but are determined therein by complex calculation methods, can be determined as the temporal parameter. It is to be understood that, according to the disclosure, a plurality of different temporal parameters can also be determined on the basis of the movement parameter ascertained and/or of the at least one occupied region. Generally, any temporal parameters used herein can be used to control and/or selectively trigger driver assistance functions (in particular, an emergency braking function).

Examples of possible temporal parameters are:
time-to-collision (TTC);
time-to-brake (TTB);
time-to-steer (TTS);
time-to-kickdown (TTK);
time-to-disappear (TTD);
time-to-enter (TTE).

The embodiment described below relates to the ascertainment of the time-to-collision as the temporal parameter. According to at least one disclosed embodiment, the occupied region ascertained (for example, on the basis of or in the vicinity model) is the current region occupied by the ego vehicle taking into consideration dimensions of the ego vehicle. The distance and optionally minimum distance of this occupied region, which may correspond to a geometric shape and/or a geometric and at least two-dimensional extent of the ego vehicle (for example, comprising its base area), from the object can then be determined. Optionally, the current region occupied by the object is likewise determined (for example, using dimensions communicated by the object and/or dimensions recorded by sensors). It is to be understood that any distance considerations discussed herein are based on the vicinity model and/or can be derived therefrom.

The following disclosed embodiment relates to ascertaining the temporal parameter as time-to-brake. According to at least one disclosed embodiment, a possible occupied region ascertained is a braking corridor of the ego vehicle (optionally again, in or on the basis of the vicinity model), wherein the braking corridor may be ascertained on the basis of an (expected) braking distance of the ego vehicle. The braking corridor can be the region, and/or comprise the region, through which the transportation vehicle travels up to a complete standstill and/or until the end of the braking operation. In other words, it can be a region that extends in the driving direction of the transportation vehicle and the size of which (in particular, the extent in the driving direction) is determined on the basis of the expected braking behavior of the ego vehicle. This braking behavior can be described, for example, by the expected braking distance. The latter can be determined as a resultant braking distance from a current speed of the ego vehicle and a maximum possible deceleration.

The temporal parameter can be zero if an object is located directly within the braking corridor (that is to say braking is immediately required in that case and/or already too late). Accordingly, it is possible to continuously check (for example, by distance sensors of the ego vehicle) whether an object enters the braking corridor, and then an emergency braking function can be activated in an automated manner on the basis of a temporal parameter that is too small (for example, having the value zero).

The following disclosed embodiment relates to ascertaining the temporal parameter as time-to-steer. According to at least one disclosed embodiment, the possible occupied region ascertained is at least one turning circle of the ego vehicle. Optionally, two turning circles of the ego vehicle are ascertained. These can result from steering the ego vehicle to the left or steering it to the right because the transportation vehicle can turn with both steering directions or steering angles. The occupied regions can again be modeled in the vicinity model and be juxtaposed, for example, with an expected movement behavior and/or occupied region, likewise modeled there, for other transportation vehicles.

The following disclosed embodiment relates to ascertaining the temporal parameter as time-to-kickdown. According to at least one disclosed embodiment, the possible occupied region ascertained is a movement corridor of the object (for example, in or on the basis of the vicinity model). In this context, provision is furthermore made for the temporal parameter to be ascertained on the basis of a (optionally minimum) distance between the region occupied by the object and the ego vehicle if the ego vehicle assumes a position reachable by performing a (predetermined) avoidance maneuver (in particular, what is known as a kickdown, i.e., a maximum possible acceleration specification by the driver). In particular, it is possible in this connection to first determine, as the temporal parameter, the previously mentioned time-to-collision, in particular, on the basis of the procedure described herein. Then it is possible to ascertain what position the ego vehicle can reach within this time-to-collision if it performs a predetermined avoidance maneuver (in particular, the kickdown described). This position can then be used to determine a distance from the described region occupied by the object. All these considerations can also be modeled in and/or derived from the vicinity model.

The movement corridor defined can generally be the two-dimensional region that encompasses an expected driving route or an expected movement of the object (in particular, if this is also a transportation vehicle). For this purpose, for example, a current driving direction and/or driving speed of the object can be used and/or the movement corridor can be determined on the basis of an extrapolation of the current region occupied by the object in its driving direction.

The following disclosed embodiment relates to ascertaining the temporal parameter as time-to-disappear or as time-to-enter. According to at least one disclosed embodiment, a movement corridor (also travel corridor) of the ego vehicle is ascertained as a possible occupied region and furthermore a current region occupied by the object is ascertained, and the temporal parameter is determined as a function of a distance between the two occupied regions. All these parameters can be derived from and/or modeled in the vicinity model. In this case, the distance between the occupied regions and a relative speed as the movement parameter may be used to determine either a minimum distance until the object enters the movement corridor (for time-to-enter) or a maximum distance that the object must travel to leave the movement corridor (for time-to-disappear). For this purpose, assumptions relating to the driving direction of the object can be made and/or the driving direction is detected by way of sensor or by way of vehicle-to-vehicle communication. This respective distance can then be combined by calculation with the movement parameter (optionally, by forming a quotient) to ascertain the respective temporal parameter.

It is to be understood that the method described here can generally be implemented by computer and is performable by a control device of the type described below.

Thus, the disclosed embodiments also relate to a control device for a transportation vehicle (in particular, any ego vehicle described herein), wherein the control device is furthermore configured to carry out a method according to any of the embodiments described herein.

For this purpose, the control device can have at least a processor device and/or a storage device. Program instructions that, upon execution by the processor device, cause the control device to carry out and/or provide any method measures or method operations described herein can be stored in the storage device. The control device can be configured for communicating with any sensors described herein or with a transportation vehicle in the vicinity by way of communication links. Communication with the traffic infrastructure is also possible, for example, if the latter is configured to transmit information to transportation vehicles in the vicinity of the ego vehicle. The control device can generally be a controller.

The control device can generally be configured to check whether any temporal parameter ascertained herein meets a predetermined collision criterion and, if this is the case, the control device may be configured to initiate a predetermined countermeasure. This can comprise, for example, activating and/or performing a driver assistance function, in particular, an emergency braking function.

Using the figures that follow, examples of temporal parameters and the methods for ascertaining them will be explained in each case. The views in this case correspond to top views of the ego vehicle 10 and also an object 18 in the environment of the former. In other words, they show a view of the road correspondingly from above on a horizontal spatial plane in which the occupied regions 20 considered herein and/or general movement parameters and positions are also ascertained. These views furthermore reflect information that is stored in a vicinity model of the ego vehicle 10 and/or are derivable therefrom. This vicinity model can generally be created from a totality of available information that may have been collected only in part by way of sensor or at least by various sensor devices. Known approaches from the prior art may be used herefor. The considerations and determinations that follow may thus be based on this vicinity model and not, or at least not exclusively, on direct sensor measurements or at least not on the direct use of individual sensor measurement values. Rather, sensor measurement values can initially be fed into a vicinity model to create the latter and/or to update it, and any parameters, regions and/or distances considered herein can then be derived from the vicinity model.

FIG. 1 shows an ego vehicle 10 comprising a schematically indicated control device 12. The control device 12 is connected to at least one vicinity sensor 14 and to at least one communication device 16. The vicinity sensor 14 can be used to record any of the properties of objects in the environment described herein, for example, the dimensions and/or movement directions or movement speeds thereof. Alternatively or additionally, such information can be sent by the objects 18 (in particular, if they themselves are transportation vehicles) to the communication device 16. It is likewise possible that other units (for example, an intelligent traffic infrastructure) transmit corresponding information to the communication unit 16.

The control unit 12 is generally configured to perform any calculations or determinations described below, for example, using a vicinity model of the ego vehicle 10 generated from various data sources (in particular, different sensor devices) and/or sensor measurements. Furthermore, it is configured to determine on the basis of the temporal parameters whether a driver assistance function and an emergency braking function needs to be activated.

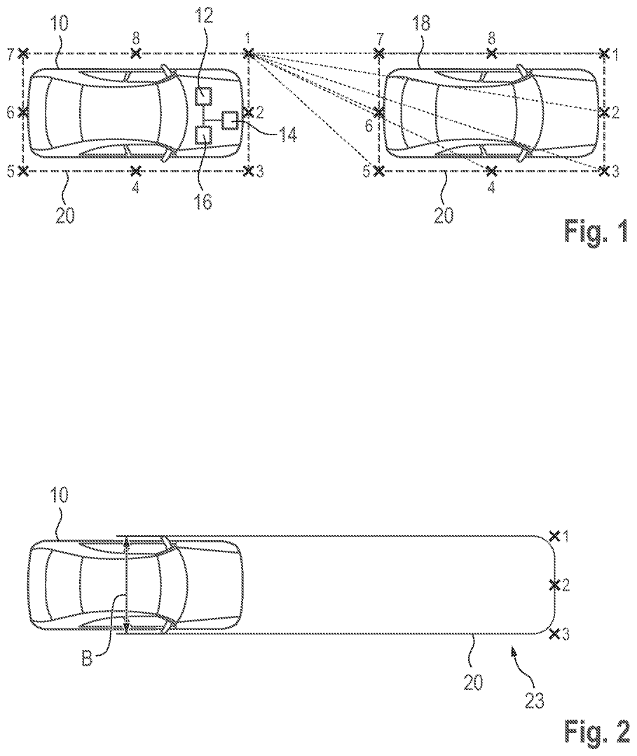

Even if this is not repeated for the FIGS. 2 to 5 below, it is to be understood that the ego vehicles 10 shown there can be designed in the same way as the embodiment disclosed in FIG. 1 and optionally have a control device 12 with a similar range of functions.

FIG. 1 shows that current two-dimensional occupied regions 20 are ascertained both for the ego vehicle 10 and also for a transportation vehicle 18 driving ahead (which is an example of an object that is under consideration here). Merely by way of example, a rectangular shape was selected for this. The current occupied regions 20 represent outlines of the transportation vehicles 10, 18, with the latter being schematically simplified (that is to say, an actual outer contour of the transportation vehicles 10, 18 is only roughly approximated). The occupied regions 20 are defined or spanned by a plurality of points labeled 1 to 8. In each case two-dimensional coordinates are ascertained for these points. The occupied regions 20 are thus a dataset or a set of two-dimensional coordinate values of points 1 to 8, the number of which is here merely an example, however. The coordinate values and consequently the occupied regions 20 can be derived from the vicinity model of the ego vehicle 10 rather than measured directly by way of sensor.

More specifically, in the case of the ego vehicle 10, the point coordinates are determined in a coordinate system of a vicinity model of the ego vehicle 10 (which is not illustrated separately). For this purpose, the ego vehicle 10 (in particular, its control unit 12) only needs to know its position and its dimensions.

For the transportation vehicle 18 driving ahead, the coordinates of points 1 to 8 in the vicinity model can be determined on the basis of information transmitted to the communication device 16 of the ego vehicle 10 or using measurement values from vicinity sensors of the ego vehicle 10 (for example, at least the coordinates of points 4 to 8).

Subsequently, a distance, and more specifically a minimum distance, between these occupied regions 20 is determined, wherein again the vicinity model or the coordinate values defined therein is/are used. More specifically, the distances for each of the points 1 to 8 of the ego vehicle 10 from in each case the points 1 to 8 or generally any known points of the occupied region 20 of the transportation vehicle 18 driving ahead are ascertained. The minimum distance value that, for example, corresponds to the distance of point 1 of the ego vehicle 10 (or its occupied region 20) from point 7 of the transportation vehicle 18 driving ahead (or its occupied region 20) is selected from the multiplicity of distance values ascertained in that way.

This minimum distance is subsequently divided by a relative speed of the ego vehicle 10 and of the transportation vehicle 18 driving ahead. This relative speed is an example of a movement parameter under consideration here. The control unit 12 can for this purpose ascertain the speed of the ego vehicle 10, for example, using speed sensors (not shown), and the vicinity sensors 14 of the ego vehicle 10 can determine the speed of the transportation vehicle 18 driving ahead.

The quotient described of a minimum distance and a relative speed gives the time-to-collision as the temporal parameter ascertained. This can be expressed by the following equation 1, with the two objects mentioned therein being the ego vehicle 10 and the transportation vehicle 18 driving ahead.

$$TTC = \frac{minimum distance between the two objects}{relative speed of the two objects} = \frac{{d}_{min}}{{v}_{rel}}$$

FIG. 2 again shows the ego vehicle 10 and its possible braking corridor 23 as the occupied region 20. The braking corridor 23 comprises the locations or the region which the ego vehicle 10 will occupy when braking optionally to a complete standstill (that is to say, the region through which the ego vehicle 10 will travel until it comes to a standstill).

Optionally, emergency braking with maximum negative acceleration is assumed here.

The control unit 12 (not shown in FIG. 2) can furthermore ascertain a current speed of the ego vehicle 10 and the driving direction thereof. Owing to previously determined braking parameters (in particular, a maximum possible deceleration) and in the knowledge of, for example, a width dimension B of the ego vehicle 10, the two-dimensionally depicted braking corridor 23 can then be determined as a corresponding possible future occupied region 20. This definition in turn can be realized again in or on the basis of a vicinity model, wherein the occupied region 20 can include a corresponding coordinate set of the vicinity model.

Merely by way of example, this occupied region 20 is described by three individual points on its front boundary, which are distributed along the width dimension B of the ego vehicle 10 or the corresponding dimension of the occupied region 20. Two-dimensional coordinates can in turn be ascertained for these points labeled 1 to 3. Similar as for the calculation for the time-to-collision in FIG. 1, distances between these points 1 to 3 of the occupied region 20 from an object 18 (not illustrated) in the vicinity and from a transportation vehicle driving ahead and optionally its current occupied region 20 (see FIG. 1) can then be determined. With further preference, the minimum distance is again ascertained here. Forming the quotient to the relative speed of the ego vehicle 10 and the corresponding object 18 in the vicinity yields the time-to-brake.

The procedure described above will be explained with reference to the following equations 2 and 3. The maximum brake acceleration α is obtained from the product of a static friction coefficient μ and the gravitational acceleration G. The braking distance d traveled by the ego vehicle 10 can be determined, taking into account its speed v, by the following equation 2:

$$d = \frac{{v}^{2}}{2 \cdot α} = \frac{{v}^{2}}{2 \cdot μ \cdot g}$$

For the time-to-brake, with the braking corridor 23 as the occupied region 20 of the ego vehicle 10, the following (equation 3) is thus obtained:

$$TTB = \frac{minimum distance braking corridor and object}{relative speed of both objects} = \frac{{d}_{min}}{{v}_{rel}}$$

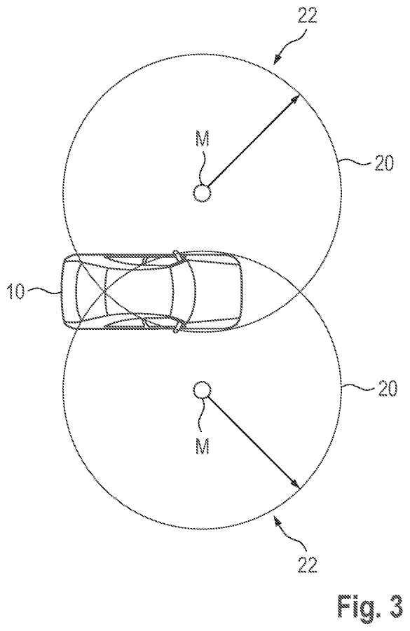

The determination of the time-to-steer temporal parameter will be explained on the basis of FIG. 3. Generally, this temporal parameter indicates the maximum time period or the last time within which/at which a transportation vehicle can prevent a collision by avoidance with optionally maximum steering angle. It is proposed here to determine turning circles (at least one) 22 as possible two-dimensional occupied regions 20 for the ego vehicle 10 in and/or on the basis of the vicinity model. These turning circles are shown in FIG. 3. The upper one here relates to a turning circle 22 when steering to the left. The bottom one is a turning circle 22 when steering to the right. The turning circles 22, and more specifically their radii, may be determined as a function of speed and/or as a function of a static friction that is present. Generally, any approaches known in the prior art and estimation methods can be selected to determine the static friction, or a constant value can be stored for it. The positioning of the turning circles 22 relative to the ego vehicle 10 takes place here as a function of the axle geometry or the chassis construction.

For a maximum steering angle, the smallest possible turning radius rmin can be determined as follows, with a given transportation vehicle speed v, gravitational acceleration g, and static friction μ (equation 4):

$${r}_{min} = \frac{{v}^{2} * ( cos ( α ) - μ * sin ( α ) )}{g ( μ \cdot cos ( α ) + sin ( α ) )} \approx \frac{{v}^{2}}{g \cdot μ}$$

In this equation, α denotes a gradient angle of the road, although this can be neglected in a purely two-dimensional consideration. It is to be understood that constructional boundaries for the turning radius rmin exist, and as a result it cannot be selected to be arbitrarily small. For example, a value determined by equation 4 can be assessed as being invalid if it lies under the constructional limit.

In general terms, a collision can no longer be prevented if an object 18 is located within one of the turning circles 22. However, it is possible, for example, to steer around an object 18 located in only one of the turning circles 22 by steering into or driving through the correspondingly other turning circle 22.

To determine the TTS temporal parameter, the coordinates of the centers M of the turning circles 22 are determined, for example, in the vicinity model. These are fixed relative to the ego vehicle 10 (for example, along its front axle and at a distance, depending on the radius rmin, for example, from a wheel of the ego vehicle 10 at the front axle located on the outside of the curve), as explained above, for constructional reasons. The minimum distance between each of the circle centers M and an object 18 (not illustrated in FIG. 2) in the vicinity is then ascertained. An occupied region 20 around a transportation vehicle 18 driving ahead can then be defined, for example, analogously to FIG. 1, and the distances of any circle center M from the individual locations 1 to 8 of this occupied region 20 can be calculated. The circle radius rmin is subtracted from this distance to obtain the distance between the outer circumference of each turning circle 22 and the object 18.

If the distance is zero or less, the object 18 is already located in one of the turning circles 22 and it is no longer possible to avoid it, or it is possible to avoid it only by steering into the other direction or according to the turning circle 22 without the object 18. If two turning circles 22 are under consideration, minimum distances for both of the turning circles 22 are determined, and the greater of these minimum distances is then used for the TTS temporal parameter. The background for this is that the avoidance maneuver that is more suitable from the driver's point of view (due to the time that still remains) should be favoured.

The discussed distances between a current occupied region 20 of a transportation vehicle, generally modeled as a rectangle, and a turning circle (also generally between a rectangle and a circle) can be determined particularly precisely by what are known as clamping methods or max-min functions.

For calculating the TTS temporal parameter, the following equation 5 can be used:

$$TTS = \frac{minimum distance turning circle and object}{relative speed of the two objects} = \frac{{d}_{min}}{{v}_{rel}}$$

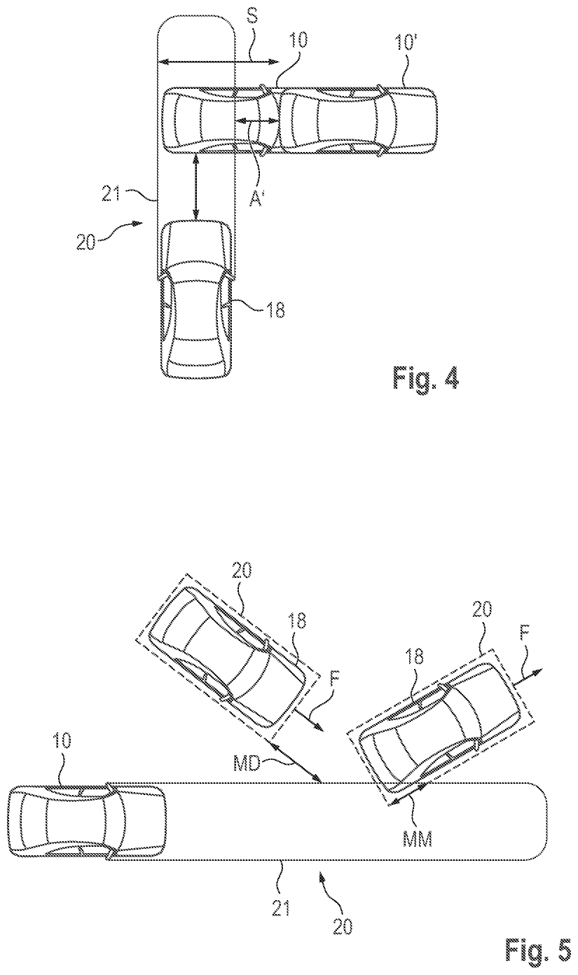

Using FIG. 4, one possibility for calculating the TTK (time-to-kickdown) temporal parameter will be described below. It shows an alter transportation vehicle 18, for which a two-dimensional occupied region 20 in the sense of a movement or travel corridor 21 is determined, optionally as a coordinate set in a vicinity model. Again, dimensions, driving direction and/or driving speed of the transportation vehicle 18 can be communicated and/or recorded herefor. The ego vehicle 10 is here shown in a left-hand starting position and also in a right-hand future position 10′, which it can reach with abrupt maximum acceleration (kickdown by the driver).

For this avoidance maneuver, the TTC time is available, which can be determined analogously to the embodiment disclosed in FIG. 1. Based on this time and the maximally possible acceleration of the ego vehicle 10, which is specified, for example, constructionally and known, it is possible to determine the future position 10′ that is maximally reachable within the TTC. More specifically, the maximally travelable driving distance S within the TTC with maximum acceleration can be determined.

Subsequently, with the known future position 10′, a distance A′ between the movement corridor 21 and the ego vehicle 10 at its future position 10′ is ascertainable. This distance A′ represents the minimum distance between the movement corridor 21 and the ego vehicle 10 at the future position 10′. Accordingly, the TTK temporal parameter can be determined according to the following equation 6:

$$TTK = \frac{\begin{matrix}minimum distance travel corridor object \\ and ego vehicle with {α}_{max}\end{matrix}}{relative speed of the two objects} = \frac{{d}_{min}}{{v}_{rel}}$$

Using FIG. 5, possibilities for determining a TTD and a TTE (time-to-disappear, time-to-enter) temporal parameter will be discussed below. It shows an ego vehicle 10 and its possible movement corridor 21 (also ego travel corridor) as its possible two-dimensional occupied region 20, which is defined again as a coordinate set in a vicinity model of the ego vehicle 10. It furthermore shows two different scenarios, specifically a further transportation vehicle 18 driving in the direction of the movement corridor 21 (see driving direction arrow F). It furthermore shows a transportation vehicle 18 on the right, which is still located in the movement corridor 21 but is in the process of leaving it. For both of these transportation vehicles 18, current occupied regions 20 are determined analogously to the embodiment disclosed in FIG. 1. Distances between these occupied regions 20 and the movement corridor 21 are then determined again, wherein again point coordinates of the occupied regions 20 analogously to FIG. 1 can be used.

In the case of the left-hand transportation vehicle 18, the minimum distance MD between the occupied region 20 and the movement corridor 21 is determined. In the case of the right-hand transportation vehicle 18, the maximum distance MM is determined, which the transportation vehicle 18 must travel to leave the movement corridor 21 (i.e., the maximum overlap extent of its occupied region 20 and the movement corridor 21 is determined). Using the following equations 7 and 8, the relevant temporal parameters can then be determined as follows:

$$\begin{matrix}TTD = \frac{\begin{matrix}maximum distance ego travel corridor and \\ obstacle vehicle\end{matrix}}{relative speed ego travel corridor and obstacle vehicle} = \frac{{d}_{max}}{{v}_{rel}} & 7 \\ TTE = \frac{\begin{matrix}minimum distance ego travel corridor \\ and obstacle vehicle\end{matrix}}{relative speed ego travel corridor and obstacle vehicle} = \frac{{d}_{min}}{{v}_{rel}} & 8\end{matrix}$$

The ego travel corridor here corresponds to the movement corridor 21. The speed of this ego travel corridor relative to the obstacle transportation vehicle is here understood to be a relative speed with which the ego travel corridor moves towards or away from the entering or departing transportation vehicle 18. In the case shown, travel along a curve by the ego vehicle would be necessary herefor, with the result that the ego travel corridor (or the movement corridor 21) is steered in the direction of the transportation vehicle 18 or away therefrom. This has corresponding effects on the previously discussed temporal parameters, which is taken into account in equations 7 and 8. The ego travel corridor can also be considered to be infinite in the driving direction. This underlines that the relative speed changes only when correspondingly driving along curves or for steering maneuvers in relation to the transportation vehicles 18.

List of Reference Signs

10 Ego vehicle

10′ Ego vehicle at future position after kickdown

12 Control device

14 Vicinity sensor

16 Communication device

18 Object/transportation vehicle driving ahead

20 Occupied region

21 Movement corridor

22 Turning circle

23 Braking corridor

B Width dimension

M Center

S Driving distance

F Driving direction

A′ Distance after kickdown

MD Minimum distance

MM Maximum distance

1. A method for ascertaining a temporal parameter for describing a possible collision of an ego vehicle with at least one further object, the method comprising:
ascertaining a movement parameter that is dependent on a movement of at least one of the ego vehicle and the at least one further object;
ascertaining a current and/or possible occupied region for at least one of the ego vehicle and the at least one further object; and
ascertaining the temporal parameter based on the movement parameter and the occupied region,
wherein the occupied region is ascertained based on a vicinity model of the ego vehicle.

2. The method of claim 1, wherein the temporal parameter is ascertained based on a distance between the occupied region and the correspondingly other of the ego vehicle and the object,
wherein the temporal parameter is determined based on a quotient of the distance divided by the movement parameter, and
wherein the movement parameter is a relative speed between the ego vehicle and the object.

3. The method of claim 1, wherein the current occupied region of the ego vehicle is ascertained as the occupied region taking into account dimensions of the ego vehicle.

4. The method of claim 1, wherein a braking corridor of the ego vehicle is ascertained as the possible occupied region, wherein the braking corridor is ascertained based on a braking distance of the ego vehicle.

5. The method of claim 1, wherein at least one turning circle of the ego vehicle is ascertained as the possible occupied region.

6. The method of claim 1, wherein a movement corridor of the object is ascertained as the possible occupied region.

7. The method of claim 2, wherein the temporal parameter is ascertained based on a distance between the occupied region of the object and the ego vehicle in response to the ego vehicle assuming a position that is reachable by performing an avoidance maneuver.

8. The method of claim 1, wherein a movement corridor of the ego vehicle as the possible occupied region and a current occupied region of the object are ascertained, and
wherein the temporal parameter is ascertained as a function of a distance between the two occupied regions.

9. The method of claim 1, wherein the occupied region is at least two-dimensional.

10. A control device for a transportation vehicle, which is configured to ascertain a temporal parameter for describing a possible collision of an ego vehicle with at least one further object by:
ascertaining a movement parameter that is dependent on a movement of at least one of the ego vehicle and the at least one further object;
ascertaining a current and/or possible occupied region for at least one of the ego vehicle and the at least one further object; and
ascertaining the temporal parameter based on the movement parameter and the occupied region,
wherein the occupied region is ascertained based on a vicinity model of the ego vehicle.

11. The control device of claim 10, wherein the temporal parameter is ascertained based on a distance between the occupied region and the correspondingly other of the ego vehicle and the object,
wherein the temporal parameter is determined based on a quotient of the distance divided by the movement parameter, and
wherein the movement parameter is a relative speed between the ego vehicle and the object.

12. The control device of claim 10, wherein the current occupied region of the ego vehicle is ascertained as the occupied region taking into account dimensions of the ego vehicle.

13. The control device of claim 10, wherein a braking corridor of the ego vehicle is ascertained as the possible occupied region, wherein the braking corridor is ascertained based on a braking distance of the ego vehicle.

14. The control device of claim 10, wherein at least one turning circle of the ego vehicle is ascertained as the possible occupied region.

15. The control device of claim 10, wherein a movement corridor of the object is ascertained as the possible occupied region.

16. The control device of 11, wherein the temporal parameter is ascertained based on a distance between the occupied region of the object and the ego vehicle in response to the ego vehicle assuming a position that is reachable by performing an avoidance maneuver.

17. The control device of claim 10, wherein a movement corridor of the ego vehicle as the possible occupied region and a current occupied region of the object are ascertained, and
wherein the temporal parameter is ascertained as a function of a distance between the two occupied regions.

18. The control device of claim 10, wherein the occupied region is at least two-dimensional.
